(19) United States
(12) Patent Application Publication
(10) Pub. No.: US 2002/0097777 A1
(43) Pub. Date: Jul. 25, 2002

(54) Temperature indicating beverage cup

(76) Inventor: Michael Benjamin Ronci, Winston-Salem, NC (US)

Correspondence Address: Michael Ronci, 5050 Northwest Dr., Winston-Salem, NC, 27105, US

(21) Appl. No.: 09/768,560

(22) Filed: Jan. 25, 2001

(51) Int. Cl. G01K 1/14; G01K 13/00; G01K 11/12

(52) U.S. Cl. 374/157; 374/150; 374/161; 116/216; 374/162

(57) ABSTRACT

Temperature Indicating Beverage Cup comprising: a ceramic beverage holding cup, an integral, applied thermochromatic display fixedly printed on the outside wall of said ceramic cup, said thermochromatic display having a plurality of printed segments, each said segment correlating to a temperature range, and said segments revealing a written or numeric display as the temperature causes said thermochromatic to transition from opaque to transparent.

### BACKGROUND OF THE INVENTION

This invention relates generally to the field of temperature measuring devices, and more particularly to a temperature indicating beverage cup.

Beverage holding cups are known. Ceramic type beverage holding cups are commonly used to contain hot beverages such as coffee or tea. Traditionally, a person who wishes to test the degree of hotness of a beverage must carefully take a small sip of the hot liquid.

If not done with extreme caution this process can cause actual burns in a persons mouth or lips. There is therefore a need for a method of determining the temperature of a hot beverage before that beverage is drunk by a person.

### SUMMARY OF THE INVENTION

The primary object of the invention is To provide a beverage holding cup that is able to indicate to the user the relative temperature and therefore drinkability of a hot liquid contained within said beverage cup.

Other objects and advantages of the present invention will become apparent from the following descriptions, taken in connection with the accompanying drawings, wherein, by way of illustration and example, an embodiment of the present invention is disclosed.

Temperature Indicating Beverage Cup comprising: a ceramic beverage holding cup, an integral, applied thermochromatic display fixedly printed on the outside wall of said ceramic cup, said thermochromatic display having a plurality of printed segments, each said segment correlating to a temperature range, and said segments revealing a written or numeric display as the temperature causes said thermochromatic display to transition from opaque to clear.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of the temperature indicating beverage cup of the present invention

FIG. 2 is a plan view of the thermographic display of the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

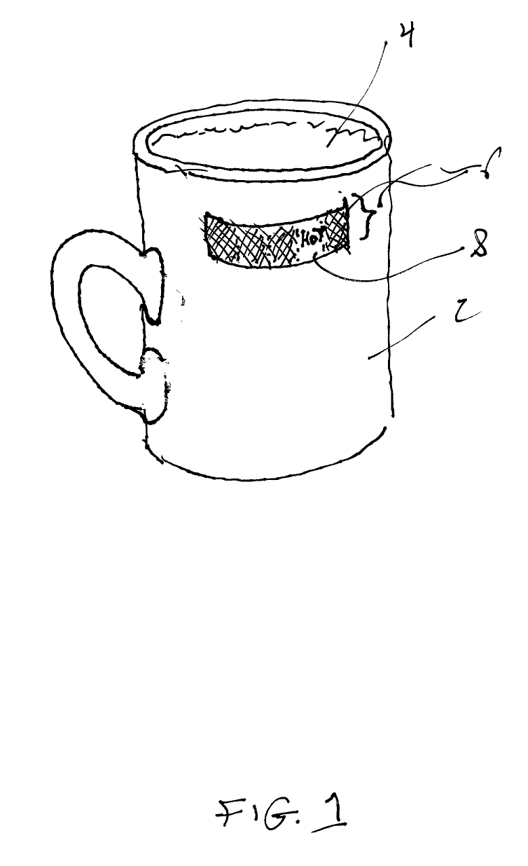

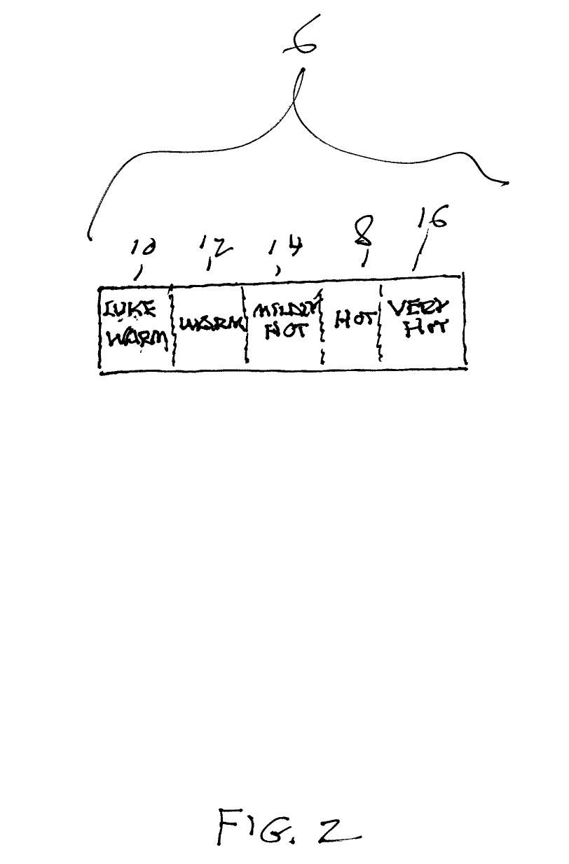

Referring now to FIG. 1 we see a perspective view of the temperature indicating beverage cup of the present invention. Ceramic beverage mug 2 is a typical construction mug construction. When a hot hot beverage 4 such as coffee or tea is poured into the mug 2 a thermochromatic display 6 is activated the display is such that when a certain temperature is reached a segment of the display turns from opaque to clear to reveal a temperature indication such as “hot” 8 is shown. Such a material is available from Chromatic Technologies Incorporated. FIG. 2 shows the preferred embodiment of the thermochromatic display. When the cup 2 is at room temperature all the segments 10, 12, 14, 8, 16 are opaque. When the temperature of forty degree's C. is reached the “luke warm” segment 10 begins to be revealed as the temperature sensitive, thermochromatic printed overlay becomes transparent. As the temperature reaches forty five degrees C. the “luke warm” segment is completely revealed because the temperature sensitive coating applied on top of the segment 10 has turned from opaque to transparent. As the temperature rises further the next segment 12 turns from opaque to transparent. This process continues segment by segment until the hottest segment 16 is reached. In the preferred embodiment shown the display is broken into five segments. The first segment 10 starts to become clear between forty degrees C. and is completely transparent at forty five degrees C. The second segment 12 starts to become clear at forty five degrees C. and is completely transparent at fifty degrees C. The third segment 14 starts to become clear at fifty degrees C. and is completely transparent at fifty five degrees C. the fourth segment 8 starts to become clear at fifty five degrees C. an is completely transparent at sixty degrees C. The fifth segment starts to become clear at sixty degrees C. and becomes completely transparent at sixty five degrees C. Of course, actual temperature numbers could be substituted for the written descriptions. Additionally, the number of segments could be greater of fewer that the five shown in the preferred embodiment. Although the preferred embodiment discloses that the thermgraphic display is perminantly printed onto the outside of a beverage cup, it is obvious that a seperate thermographic label could be manufactured and sold seperatly to be adhesivly applied by a user to his or her existing cup. The seperate, stick on label method is inferior to printing directly onto a cup because it can not account for variations in the cups wall thickness and resulting temperature variation from the inside liquid bearing wall to the outside air temperature wall. Additionally, with regard to a seperate stick on label, most double stick adhesives loose there sticking effectiveness at approximatly sixty degrees C.

In the above described and illustrated way a person using the beverage cup of the present invention can have an accurate idea of the relative temperature of the hot beverage contained within the cup thereby eliminating the sometimes painful process of testing the beverages temperature with ones lips or tongue.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Temperature Indicating Beverage Cup comprising:
a ceramic beverage holding cup;
an integral, applied thermochromatic display fixedly printed on the outside wall of said ceramic cup;
said thermochromatic display having a plurality of printed segments, each said segment correlating to a temperature range; and
said segments revealing a written or numeric display as the temperature causes said thermochromatic to transition from opaque to transparent.
